(19) United States
(12) Patent Application Publication
(10) Pub. No.: US 2023/0075874 A1
(43) Pub. Date: Mar. 9, 2023

(54) DEVICE FOR STORING AT LEAST ONE OBJECT

(71) Applicant: Heinz Franz BRUMNIK, Neuhaus (AT)

(72) Inventor: Heinz Franz BRUMNIK, Neuhaus (AT)

(21) Appl. No.: 17/795,729

(22) PCT Filed: Sep. 10, 2020
(86) PCT No.: PCT/AT2020/060330

§ 371 Date: Jul. 27, 2022

(30) Foreign Application Priority Data
Feb. 4, 2020 (AT) A 50086/2020

(51) Int. Cl. A45C 11/18; H01Q 1/22; H01Q 1/52; H01Q 1/50

(52) U.S. Cl. CPC A45C 11/182; H01Q 1/22; H01Q 1/526; H01Q 1/50; A45C 2011/186

(57) ABSTRACT

A device for storing at least one object which is designed for wireless communication, in particular for storing one or more debit cards, includes a hollow chamber in which the object can be positioned and which is at least partially shielded from electromagnetic waves of a surrounding environment by a shielding layer. In order to place an object arranged in the device in a non-readable state from a readable state in a particularly simple manner, it is provided that an external antenna for wirelessly communicating with equipment arranged in an environment surrounding the device and an internal antenna for wirelessly communicating with an object arranged in the hollow chamber are provided, wherein the internal antenna can be electrically connected to the external antenna in a reversible manner via an electric switch in order to enable a wireless communication between the equipment and the object.

The invention relates to a device for storing at least one object which is designed for wireless communication, in particular for storing one or more debit cards, comprising a hollow chamber in which the object can be positioned and which is at least partially shielded from electromagnetic waves of a surrounding environment by means of a shielding layer.

From the prior art, various devices for storing credit cards, chip cards, debit cards, or the like have become known. From the document WO 2010/097342 A2, for example, a money purse for accommodating credit cards has become known, which money purse comprises a separating element for enabling, in a targeted manner, an activation of one of multiple debit cards that are arranged in the money purse. For this purpose, the debit card that is to be activated must be arranged in front of the separating element acting as a radio wave blocker, whereas the non-activatable cards are to be arranged on a back side of the separating element so that they cannot be read due to the separating element.

Furthermore, from the document AT 517159 A1 a container for storing chip cards has become known, wherein a chip card is arranged between separating elements that can be pivoted against one another and which, when folded shut, shield electromagnetic waves from the chip card and, when folded open, enable a communication between the chip card and a reader device, such as an automated teller machine, arranged in an environment surrounding the chip card. Thus, in order to perform a payment, for example, using a chip card arranged in a corresponding container, the separating elements must be folded open, whereby the chip card is readable for the automated teller machine.

With devices from the prior art, it has proven disadvantageous that, for these devices, it is always necessary to make a physical change in order to place the debit card in a readable state from a non-readable state. Thus, either the debit card must be moved relative to the device or the device itself must be moved, as a result of which devices from the prior art are at best cumbersome to handle.

This is addressed by the invention. The object of the invention is to specify a device of the type named at the outset, with which a debit card arranged in the device can be placed in a readable state from a non-readable state even without altering a relative position between the debit card and the device.

According to the invention, this object is attained with a device of the type named at the outset, in which an external antenna for wirelessly communicating with equipment arranged in an environment surrounding the device and an internal antenna for wirelessly communicating with an object arranged in the hollow chamber are provided, wherein the internal antenna can be electrically connected to the external antenna in a reversible manner via an electric switch in order to enable a wireless communication between the equipment and the object.

In the context of the invention of the invention, it was found that a switchable shielding of a debit card from a reader device arranged in an environment surrounding the same, such as an automated bank teller or the like, can occur not only as known from the prior art, in that a separating element that shields electromagnetic waves is reversibly arranged between the debit card and the reader device, but rather also in that the debit card is essentially arranged in a shielding device and, for transmitting electromagnetic signals from a surrounding environment to the shielded debit card, an external antenna in connection with a surrounding environment and an internal antenna in connection with the hollow chamber are provided, which antennas are connected to one another in a switchable manner, so that electromagnetic waves from the surrounding environment can never directly reach the debit card, but instead do so indirectly, via the electrical connection between the external antenna and the internal antenna, when contact has been made between the external antenna and the internal antenna. It is thus no longer necessary to change a position of the debit card relative to a separating element shielding it; instead it is sufficient to close the switch, whereby handling is simplified and wear is also reduced. In this case, the switch can, of course, be designed both as a mechanical device, or as a switch that is manually actuated, as well as an electrical or electronic switch, in particular as a transistor, so that the device can also be switched by means of a smartphone, for example. Typically, the switch is designed as a mechanically actuated switch so that the device can be embodied entirely without a power supply. A signal transmission from the external antenna to the internal antenna then takes place using a current induced in the external antenna as a result of an electromagnetic wave or alternating electromagnetic field, which current reaches the internal antenna and, at said antenna, produces an alternating electromagnetic field or electromagnetic wave that reaches the hollow chamber. In this manner, a debit card arranged in the hollow chamber, which card can be designed as an RFID card for example, can be supplied with energy. Electromagnetic signals emitted by the debit card can be analogously transmitted to the external antenna via the internal antenna, and from the external antenna to the reader device such as an automated bank teller, so that a bidirectional communication is enabled. Of course, in addition to debit cards, the device can also be used for other wirelessly communicating objects which can be designed as a card or also with an appearance that differs from a card. Preferably, the device is used for NFC or RFID cards, for example for a card with which a wireless identification of a user at a charging terminal for electric vehicles is possible.

The device is typically designed for the at least partial, preferably complete, shielding of the hollow chamber from electromagnetic waves with a frequency of more than 100 kHz, in particular a frequency in a range between 1 MHz and 100 MHz, preferably a frequency of approximately 13.56 MHz.

Debit cards are typically embodied to be flat. It has therefore proven effective that the hollow chamber is bounded by two separating elements which respectively comprise a shielding layer for the at least partial shielding of electromagnetic waves and are preferably embodied to be flat. The separating elements are typically embodied to be flat and can, for instance, have a width of, for example, more than 53 mm, in particular 54 mm to 90 mm; a length of more than 85 mm, in particular 86 mm to 150 mm; and a height of less than 30 mm, in particular 0.1 mm to 10 mm, so that the separating elements can form a hollow chamber that accommodates a debit card.

In principle, it is not necessary for the shielding layer to completely encase the hollow chamber. Typically, one or more shielding layers are positioned roughly parallel to a front side and a back side, or parallel to a largest lateral surface, of the separating element, which is typically roughly cube-shaped, such that said layers can block a passage of electromagnetic waves through the front side and back side to such an extent that a wireless communication of a reader device, such as an automated bank teller for example, with an object arranged in the hollow chamber is impeded.

The shielding layer can, in principle, be embodied in any desired manner that is suitable to at least partially block or absorb electromagnetic waves. It is particularly beneficial if the shielding layer comprises a material with a permeability value of at least 4, preferably at least 50, in particular at least 100. It has been shown that a material with a permeability value of this magnitude, or a relative permeability of this magnitude, is particularly well suited to block or absorb electromagnetic waves. The shielding layer preferably comprises a continuous layer of a material of this type.

The shielding layer preferably has a size corresponding to the object that is to be arranged in the hollow chamber, in particular the size of a debit card, preferably a debit card in the ID-1 format.

To achieve a particularly good shielding of objects arranged in the hollow chamber, it is preferably provided that the shielding layer comprises a metal layer. For example, a structure of the shielding layer can be provided, wherein a metal layer follows on a layer with a high magnetic permeability, which metal layer is preferably embodied to have good electrical conductivity, whereupon another layer with a high magnetic permeability follows. The shielding layer can, for example, be positioned on a base element formed by a plastic, in order to achieve a desired mechanical stability. The base element can be produced in a 3D printing method, for example.

A simple producibility is achieved if the shielding layer comprises ferrite, in particular a continuous ferrite layer. Ferrite has a high permeability value or high relative permeability, so that a shielding layer can be formed, for example, by one ferrite layer or two ferrite layers arranged on a metal layer.

A device according to the invention can, in principle, be used for transmitting electromagnetic waves from the surrounding environment to the hollow chamber via the external antenna and the internal antenna on any desired frequencies. It is preferably provided that the external antenna and the internal antenna are suitable for receiving and sending electromagnetic waves at a frequency of more than 100 kHz, in particular a frequency in a range between 1 MHz and 100 MHz, preferably a frequency of approximately 13.56 MHz. A frequency of this type is typically used for transmitting data between debit cards and corresponding reader devices, such as automated bank teller machines, which is why a device embodied in such a manner is particularly suitable for accommodating debit cards, credit cards, and the like.

Of course, a device according to the invention can also be embodied to accommodate more than one debit card. In order to then also be able to electromagnetically connect the individual debit cards to a surrounding environment individually in a simple manner, it can be envisaged that at least two hollow chambers in which objects can be positioned are provided, with a shielding layer being arranged between the hollow chambers and one internal antenna being allocated to each of the at least two hollow chambers, wherein each internal antenna can be reversibly connected to the external antenna via an electric switch in order to enable a wireless communication between an object arranged in one of the hollow chambers and the equipment. To consequently make one of multiple cards arranged in the device readable for a reader device, such as an automated bank teller for example, arranged externally from the device, it is sufficient if a connection is produced between the internal antenna accessible to the hollow chamber in which the respective card is arranged and the external antenna using a corresponding selector switch. Normally, connections between the other internal antennas and the external antenna are interrupted in the process, so that only one internal antenna or one hollow chamber is connected to the external antenna at a time. A corresponding switch, with which the external antenna can be connected to one of multiple internal antennas, can be embodied as a selector switch, with which the external antenna can be connected to exactly one internal antenna or none of the internal antennas. The switch can be embodied as a rotary switch or as a sliding switch, for example.

Via the switch, a connection between the external antenna and each internal antenna can then also be typically disconnected simultaneously, so that all objects arranged in the device are electromagnetically disconnected from the surrounding environment and are not wirelessly readable.

Preferably, it is provided that the device comprises multiple separating elements connected to one another, wherein each separating element comprises a shielding layer which is suitable for at least partially shielding electromagnetic waves, and one or more hollow chambers are formed between the separating elements. The device can then be modularly constructed in a simple manner, so that different devices for any desired number of debit cards can easily be produced by combining corresponding modules.

It is beneficial if the separating elements are detachably connected to one another. A user can then easily adjust the size of the device by removing or adding individual separating elements, depending on how many cards the user wishes to position in the device.

In principle, the separating elements can be detachably connected to one another in widely different ways. A particularly simple way of connecting the separating elements to one another results if the separating elements are magnetically connected to one another.

It is typically provided that each separating element comprises a first ferrite layer, over which a metal layer is arranged, with a second ferrite layer being arranged over the metal layer.

It has proven effective that the device is suitable for accommodating multiple, preferably at least three, debit cards in hollow chambers electromagnetically shielded from one another, wherein an electromagnetic connection between a surrounding environment and one or more of the hollow chambers can be produced via a selector switch. The switch can be embodied as a selector switch for this purpose.

In principle, it is possible that, for a device which comprises multiple separating elements, each separating element is embodied differently. To achieve a particularly simple construction, however, it is preferably provided that multiple separating elements are identically constructed.

To achieve a particularly simple construction, it is especially beneficial if the device has a first element, which comprises the external antenna and a shielding layer that at least partially shields electromagnetic waves, and at least one second element, which comprises a shielding layer that at least partially shields electromagnetic waves and comprises the internal antenna. In this case, a first separating element, which can be arranged on an outer side, can be embodied as the first element and all other separating elements as second elements, so that a corresponding device can be embodied with only two different elements for any desired number of debit cards in that any desired number of second elements are combined with the first element. The first element and the second element are typically embodied such that, when they are connected, a hollow chamber results in which a corresponding object can be arranged.

It is preferably provided that the switch for producing an electrical connection between the external antenna and the internal antenna is provided on the first element.

In order to also be able to easily achieve an electrical connection between the external antenna and the internal antenna for this simple type of a construction, it is beneficial if the at least one second element is detachably connected to the first element, wherein electrical contacts are arranged in corresponding positions on the first element and on the second element, in order to electrically connect the internal antenna to the external antenna via the contacts when a mechanical connection between the first element and the second element is produced and the switch is closed.

It has proven effective that the second element comprises electrical contacts on a front side and on a back side, wherein at least one contact arranged on the front side is connected to at least one contact arranged on the back side, so that an internal antenna of an additional second element, which is indirectly connected to the first element via a second element connected directly to the first element, can be indirectly electrically connected to the external antenna of the first element. In this manner, any desired number of second elements can be connected to the first element, wherein an electric signal from the external antenna arranged on the first element is transmitted, via second elements arranged between the first element and a last second element, to the last second element.

It is preferably provided that the at least one contact on the front side is connected to a contact that is not arranged in a corresponding position on the back side, in particular to a contact that is in an obliquely opposite position. Typically, multiple, preferably all, contacts of one side of the second element, in particular a front side, via which contacts a second connecting line of an internal antenna can be connected to a second connecting line of the external antenna can be connected, are obliquely, that is, not perpendicular to the front side or to the back side, connected to a contact on an opposite side, in particular a back side, of the second element. The contacts are normally arranged on the front side and the back side of the second element, which back side is normally roughly parallel to the front side, in corresponding positions so that an electrical connection can be produced between contacts of two second elements that are arranged on top of one another or are connected to one another in a planar manner.

For example, a first contact arranged in a first position on a front side of a second element can be connected to the internal antenna of said second element. A second contact arranged next to the first position in a second position on the front side can, by means of an oblique connection in the second element, be connected to a contact on the back side of the second element, which contact is located in a position on the back side that corresponds to the first position on the front side, or which contact is arranged directly under the first position on the front side. If multiple second elements constructed in such a manner are positioned on top of one another so that contacts of the back side of one second element are in connection with contacts of the front side of another element, the internal antenna of the other second element arranged below a topmost second element can be reached via the contact arranged in the second position.

An internal antenna connected to the external antenna is typically connected to the external antenna via a first connecting line and a second connecting line. To disconnect the connection, it is sufficient to disconnect either the first connecting line or the second connecting line. It can therefore be sufficient if the correspondingly obliquely connected contacts are only provided for contacting the second connecting line of the respective internal antenna and the first connecting line of each internal antenna is connected to the external antenna at all times. A contact for connecting the first connecting line of the external antenna to the internal antenna on a front side of the second element can therefore, in principle, also be connected to a contact on the back side that is located directly thereunder or in a corresponding position.

Additional features, advantages, and effects of the invention follow from the exemplary embodiment described below. In the drawings which are thereby referenced:

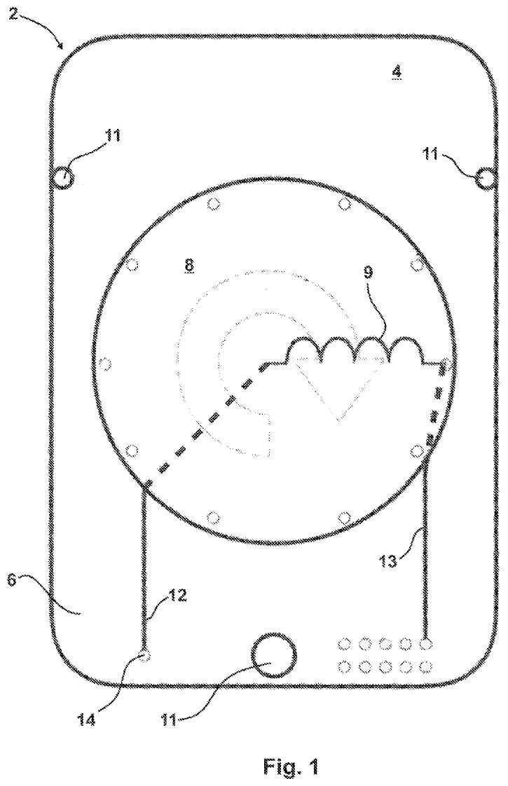

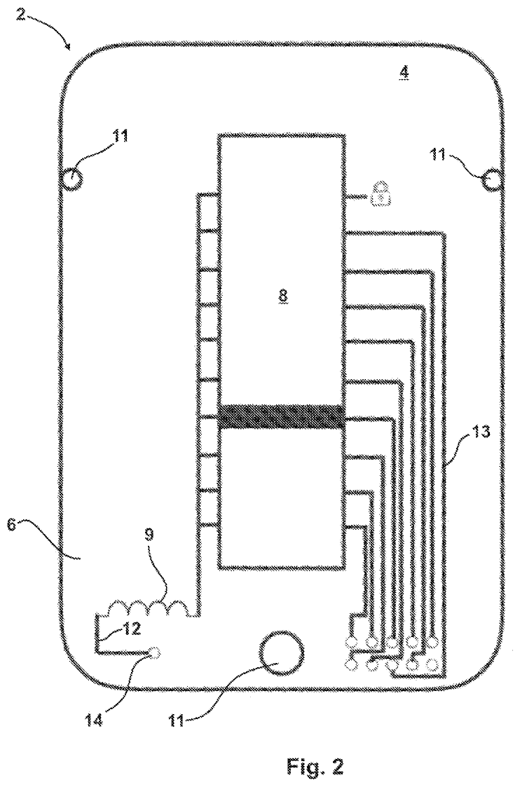

FIGS. 1 and 2 show a first element of a device according to the invention;

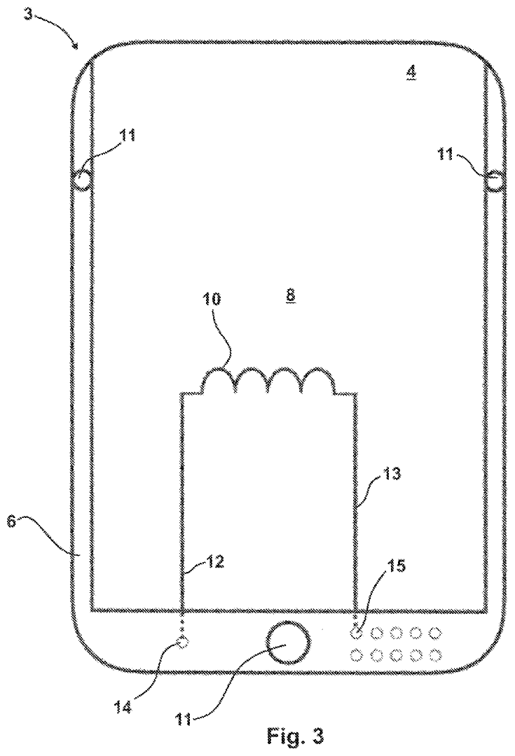

FIGS. 3 through 5 show a second element of a device according to the invention in different views;

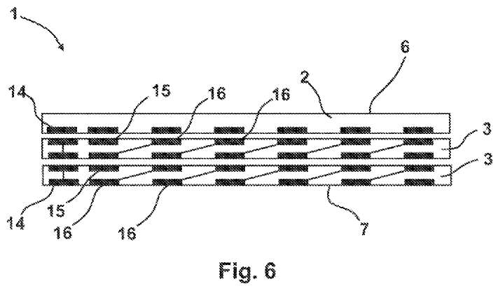

FIG. 6 shows a detailed view of a device according to the invention in a sectional illustration;

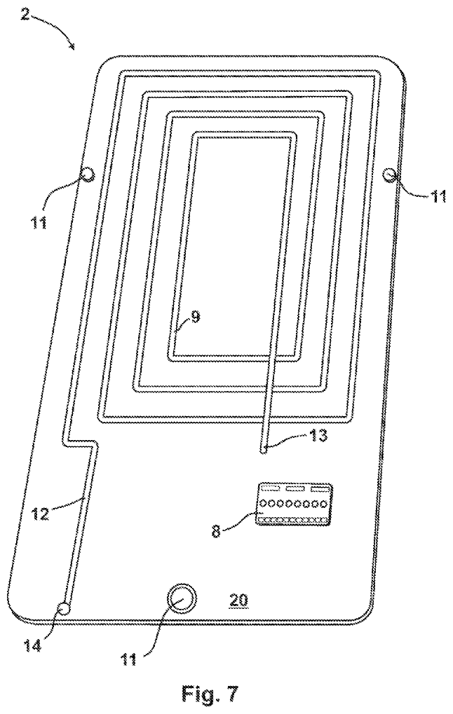

FIG. 7 shows a further first element of a device according to the invention;

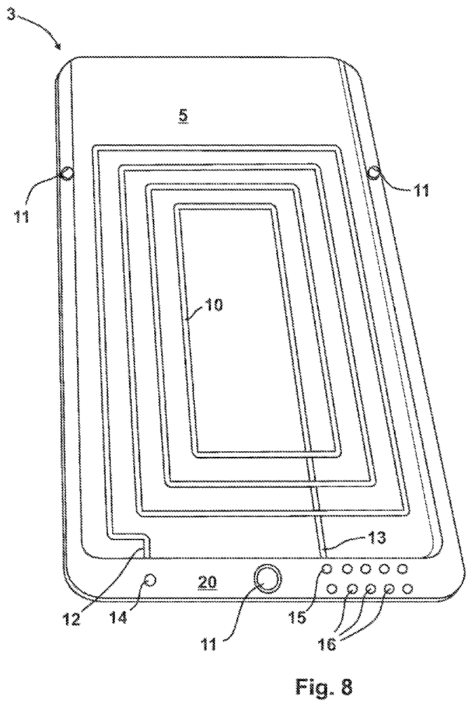

FIG. 8 shows a further second element of a device according to the invention;

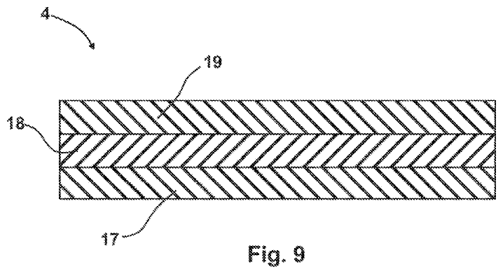

FIG. 9 shows a detailed view of a device according to the invention.

FIG. 1 shows a front side 6 of a first element 2 of a device 1 according to the invention in a schematic illustration, which element comprises an external antenna 9 and a switch embodied as a selector switch 8. The first element 2 comprises a base piece 20, which for example is produced in a 3D printing method and is composed of a plastic, on which base piece 20 a shielding layer 4 is arranged in order to shield an object arranged behind the first element 2 against electromagnetic waves located in front of the first element 2. The shielding layer 4 typically extends over an entire cross section or an entire front side 6 of the first element 2, though it can also be provided that the shielding layer 4 only extends over a portion of the cross section or a portion of the front side 6, in order to block electromagnetic waves from an antenna of a debit card arranged in the device 1. Antennas of debit cards are often arranged along an edge of the debit card.

By means of the selector switch 8, the external antenna 9 can be connected to one of multiple contacts on the first element 2, via which contacts internal antennas 10 of second elements 3 can be connected to the first element 2 by means of second connecting lines 13. A first connecting line 12 can permanently connect the external antenna 9 to the individual internal antennas 10, wherein an electrical connection can be produced via a first connecting contact 14. Thus, by means of the selector switch 8, one of multiple debit cards arranged in the device 1 can be electromagnetically connected to a surrounding environment via the external antenna 9 and a respective internal antenna 10, so that the respective debit card is readable with a reader device, such as an automated bank teller for example, arranged externally from the device 1, whereas the other debit cards am not readable. For this purpose, the contacts embodied as first connecting contact 14, second connecting contact 15, and daisy chain contacts 16 are arranged in corresponding positions on the first element 2 and on the second element 3.

To detachably connect the first element 2 to one or more second elements 3, three magnets 11 are provided in this case, which magnets allow a simple connection. Of course, additional connection fittings, which act in a force-fitting and/or form-fitting manner for example, can also be alternatively or additionally provided.

FIG. 2 shows a further first element 2 of a device 1 according to the invention. In contrast to the first element 2 illustrated in FIG. 1, the selector switch 8 is in this case not embodied as a rotary switch, but rather as a sliding switch. Here, the external antenna 9 arranged in or on the first element 2 can, via the selector switch 8, also either be disconnected from all internal antennas 10 or be connected, via one of the contacts, to an internal antenna 10 of a second element 3 connected to the first element 2, in order to relay electromagnetic signals of the surrounding environment into a respective hollow chamber or into an object, such as a debit card, arranged in the hollow chamber.

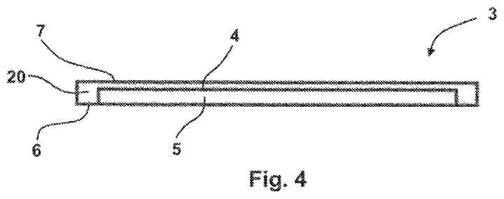

FIG. 3 and FIG. 4 schematically show a second element 3 that can be connected to one of the first 1I elements 2 illustrated in FIG. 1 or FIG. 2, wherein FIG. 3 shows the second element 3 in a front view and FIG. 4 shows the second element 3 in a top view. As can be seen, the second element 3 also comprises magnets 11 arranged correspondingly to the magnets 11 of the first element 2, in order to connect the first element 2 to the second element 3 by means of the magnets 11.

Additionally, the contacts via which the internal antenna 10 of the second element 3 is connected to the external antenna 9 of the first element 2 are also visible on the second element 3. The internal antenna 10 is, as shown, connected to the external antenna 9 via a first connecting line 12 and a second connecting line 13, so that a current induced in the external antenna 9 can flow through the internal antenna 10. In order to disconnect the internal antenna 10 from the external antenna 9, it is thus sufficient to disconnect one of the connecting lines 12, 13 from the external antenna 9. A reversible electrical disconnection of this type of the internal antenna 10 from the external antenna 9 occurs in the exemplary embodiment using the selector switch 8 arranged on the first element 2, with which switch the second connecting line 13 can be disconnected from the external antenna 9. The first connecting line 12 of one or each internal antenna 10 can thus also be permanently connected to the external antenna 9. For this purpose, a first connecting contact 14 can be provided which connects the first connecting line 12 of multiple second elements 3, which are arranged behind one another and are connected, to the external antenna 9.

As can be seen in FIG. 4, the second element 3 has a recess 5 in the top view. When the second element 3 is connected to another second element 3 or a first element 2 via the front side 6, this recess 5 forms a hollow chamber in which an object such as a debit card can be arranged. The second element 3 also comprises a shielding layer 4, so that the hollow chamber is essentially shielded from electromagnetic waves. Typically, the hollow chamber is shielded from electromagnetic waves at least to such an extent that a reading of a debit card arranged in the hollow chamber using a common reader device, such as an automated teller machine or the like, is not possible.

Of course, it can also be alternatively provided that both the first connecting line 12 and also the second connecting line 13 can be disconnected by means of the selector switch 8.

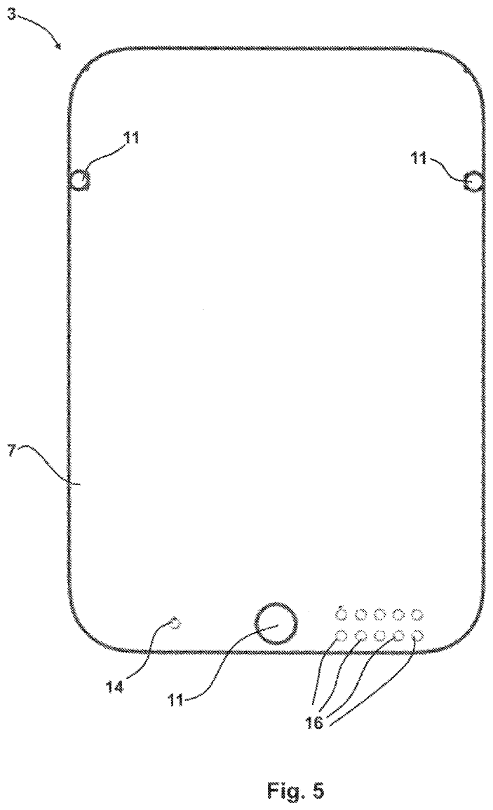

FIG. 5 shows the back side 7 of the second element 3 illustrated in FIG. 3. As can be seen, contacts are in this case also provided in order to connect a second connecting line 13 of an additional second element 3 indirectly connected to the first element 2 via the second element 3 to the external antenna 9.

FIG. 6 schematically shows how the contacts of the second element 3 are connected between a front side 6 and a back side 7 when the first element 2 and the second element 3 are assembled to form a device 1 according to the invention. For a better illustration, the first element 2 and the second elements 3 are illustrated here such that they are slightly spaced apart from one another.

As can be seen, contacts of a first element 2, of a second element 3 directly connected to the first element 2, and of an additional second element 3 are illustrated, which additional second element 3 is indirectly connected to the first element 2 via the second element 3 directly connected to the first element 2. The second element 3 and the additional second element 3 are identically constructed in this case.

As can be seen, a first connecting contact 14, to which the first connecting line 12 of the second element 3 or the first connecting line 12 of the additional second element 3 is connected, is respectively in the same position. The internal antenna 10 of the second element 3 is respectively connected to the first connecting contact 14 of the respective second element 3 on the one side and to a second connecting contact 15 of the respective second element 3 on the other side, which second connecting contact 15 is in this case located next to the first connecting contact 14. The other contacts are used for daisy-chaining additional second elements 3 arranged behind the second element 3 and can also be referred to as daisy chain contacts 16. For this purpose, the daisy chain contacts 16 are, as illustrated, not vertically, but rather obliquely connected between the front side 6 and the back side 7 so that, for example, a second connecting line 13 of the additional second element 3 can be contacted on the front side 6 of the second element 3 via a daisy chain contact located next to the second connecting contact 15. As a result, the production of a device 1 for any desired number of debit cards is easily possible using just two different elements 2, 3, the first element 2 and the second element 3, which thus form separating elements with shielding layers.

FIGS. 7 and 8 show a first element 2 and a second element 3 of a further device 1 according to the invention 1, wherein FIG. 7 shows the first element 2 and FIG. 2 shows the second element 3. It can be seen that both the external antenna 9 and also the internal antenna 10 extend over a large portion of a cross section of the device 1 in order to be able to effectively receive and relay electromagnetic waves. The recess 5 that is also arranged in the second element 3 in this case has dimensions corresponding to a debit card, so that the device 1 can easily be used to store debit cards. The switch is embodied here as a rocker switch, wherein multiple internal antennas 10 could, in principle, also be connected to the external antenna 9 in this embodiment. Here, the first element 2 illustrated and the second element 3 comprise a base piece 20 of plastic on which the additional components such as the shielding layer 4, the external antenna 9, and the selector switch 8 or the internal antenna 10 are arranged.

FIG. 9 shows a structure of a shielding layer 4 that is arranged both on the first element 2 and also on the second element 3 in order to shield the hollow chamber from electromagnetic waves. The shielding layer 4 comprises in the middle a metal layer 18 which is covered by a lower ferrite layer 17 and an upper ferrite layer 19.

With a device 1 according to the invention, it is possible, in a particularly simple manner, to activate one of multiple debit cards arranged in the device 1 for a wireless communication or to shield all debit cards arranged in the device 1 from a surrounding environment, namely without a position of the debit cards relative to the device 1 needing to be changed. This results in simple handling and a robust construction of the device 1.

1. A device for storing at least one object which is designed for wireless communication, in particular for storing one or more debit cards, comprising a hollow chamber in which the object can be positioned and which is at least partially shielded from electromagnetic waves of a surrounding environment by a shielding layer, wherein an external antenna for wirelessly communicating with equipment arranged in an environment surrounding the device for wirelessly communicating with an object arranged in the hollow chamber are provided, wherein the internal antenna can be electrically connected to the external antenna in a reversible manner via an electric switch in order to enable a wireless communication between the equipment and the object, wherein at least two hollow chambers in which objects can be positioned are provided, with a shielding layer being arranged between the hollow chambers and one internal antenna being allocated to each of the at least two hollow chambers, wherein each internal antenna can be reversibly connected to the external antenna via an electric switch in order to enable a wireless communication between an object arranged in one of the hollow chambers and the equipment.

2. The device according to claim 1, wherein the hollow chamber is bounded by two separating elements, which respectively comprise a shielding layer for the at least partial shielding of electromagnetic waves and are preferably embodied to be flat.

3. The device according to claim 1, wherein the shielding layer comprises a material with a permeability value of at least 4, preferably at least 50, in particular at least 100.

4. The device according to claim 1, wherein the shielding layer comprises ferrite, in particular a continuous ferrite layer.

5. The device according to claim 1, wherein the shielding layer comprises a metal layer.

6. The device according to claim 1, wherein the external antenna and the internal antenna are suitable for receiving and sending electromagnetic waves at a frequency of more than 100 kHz, in particular a frequency in a range between 1 MHz and 10 MHz, preferably a frequency of approximately 13.56 MHz.

7. (canceled)

8. The device according to claim 1, wherein the device comprises multiple separating elements connected to one another, wherein each separating element comprises a shielding layer which is suitable for at least partially shielding electromagnetic waves, and one or more hollow chambers are formed between the separating elements.

9. The device according to claim 8, wherein the separating elements are detachably connected to one another.

10. The device according to claim 8, wherein the separating elements are magnetically connected to one another.

11. The device according to claim 8, wherein each separating element comprises a first ferrite layer, over which a metal layer is arranged, with a second ferrite layer being arranged over the metal layer.

12. The device according to claim 1, wherein the device is suitable for accommodating multiple, preferably at least three, debit cards in hollow chambers electromagnetically shielded from one another, wherein an electromagnetic connection between a surrounding environment and one or more of the hollow chambers can be produced via a selector switch.

13. The device according to claim 1, wherein the device has a first element, which comprises the external antenna and a shielding layer that at least partially shields electromagnetic waves, and at least one second element, which comprises a shielding layer that at least partially shields electromagnetic waves and comprises the internal antenna.

14. The device according to claim 13, wherein the switch for producing an electrical connection between the external antenna and the internal antenna is provided on the first element.

15. The device according to claim 13, wherein the at least one second element is detachably connected to the first element, wherein electrical contacts are arranged in corresponding positions on the first element and on the second element, in order to electrically connect the internal antenna to the external antenna via the contacts when a mechanical connection between the first element and the second element is produced and the switch is closed.

16. The device according to claim 15, wherein the second element comprises electrical contacts on a front side and on a back side, wherein at least one contact arranged on the front side is connected to at least one contact arranged on the back side, so that an internal antenna of an additional second element, which is indirectly connected to the first element via a second element connected directly to the first element, can be indirectly electrically connected to the external antenna of the first element.

17. The device according to claim 16, wherein the at least one contact on the front side is connected to a contact that is not arranged in a corresponding position on the back side, in particular to a contact that is in an obliquely opposite position.
